(19) United States
(12) Patent Application Publication
(10) Pub. No.: US 2020/0023726 A1
(43) Pub. Date: Jan. 23, 2020

(54) CONTROL DEVICE

(71) Applicant: AISIN AW CO., LTD., Anjo-shi, Aichi-ken (JP)

(72) Inventors: Kohei TSUDA, Nishio (JP); Takashi YOSHIDA, Nishio (JP)

(73) Assignee: AISIN AW CO., LTD., Anjo-shi, Aichi-ken (JP)

(21) Appl. No.: 16/489,936

(22) PCT Filed: Jan. 12, 2018
(86) PCT No.: PCT/JP2018/000644

§ 371 Date: Aug. 29, 2019

(30) Foreign Application Priority Data
Mar. 31, 2017 (JP) 2017-070519

(51) Int. Cl. B60K 6/48; B60L 15/20

(52) U.S. Cl. CPC B60K 6/48; B60L 50/16; B60L 15/20

(57) ABSTRACT

A control device that controls a vehicle drive device in which an engagement device, a rotating electrical machine, and an automatic transmission are arranged in this order from an input side on a power transmission path connecting an input drivingly coupled to an internal combustion engine and an output drivingly coupled to a wheel, the control device including: an electronic control unit configured to operate when starting of the internal combustion engine and downshifting are performed in parallel in a state in which the internal combustion engine is stopped and the engagement device is disengaged so that torque of the rotating electrical machine is transmitted to the wheel.

### BACKGROUND

The present disclosure relates to control devices that control a vehicle drive device in which an engagement device, a rotating electrical machine, and an automatic transmission are arranged in this order from the input member side on a power transmission path connecting an input member drivingly coupled to an internal combustion engine and an output member drivingly coupled to wheels.

Regarding a technique of controlling such a vehicle drive device when starting an internal combustion engine, JP 2007-431070 As described below, for example, discloses the following control device. When a request to start an internal combustion engine is detected during traveling in an EV mode in which the torque of a rotating electrical machine is transmitted to wheels with the internal combustion engine being stopped, this control device control the stopped internal combustion engine to be dragged and start by drag torque of a first clutch between the internal combustion engine and the rotating electrical machine. During such starting of the internal combustion engine, this control device performs control to slip a second clutch, which is one of engagement clutches of an automatic transmission which establishes a shift speed. JP 2007-131070 A also describes that, in the case where the shift speed is changed by downshifting etc. during such starting of the internal combustion engine, the second clutch to be slipped may be changed according to the difference between the engagement clutches for the original shift speed and the engagement clutches for the changed shift speed.

In the case where the driver presses down hard on the accelerator during traveling in the EV mode described above, starting of the internal combustion engine and downshifting of the automatic transmission are performed so that large torque can be transmitted to the wheels. In this situation, it is required that large torque be transmitted to the wheels as soon as possible in response to the driver's request. In the control technique of JP 2007-131070 A, however, the rotating electrical machine needs to output, during starting of the internal combustion engine, the torque for increasing the rotational speed of the internal combustion engine to a rotational speed at which the internal combustion engine is able to be started and the torque for increasing the rotational speeds of the internal combustion engine and the rotating electrical machine according to the downshifting of the automatic transmission, in addition to the torque for driving the wheels. Since the torque that can be output by the rotating electrical machine is limited, the torque that is transmitted to the wheels is reduced accordingly. Accordingly, regardless of the driver's request, only the torque that is significantly smaller than the maximum torque of the rotating electrical machine can be transmitted to the wheels until both starting of the internal combustion engine and downshifting of the automatic transmission are completed, which makes the driver feel that acceleration of the vehicle is slow.

### SUMMARY

An exemplary aspect of the disclosure implements a technique that enables large torque to be quickly transmitted to wheels even when starting of an internal combustion engine and downshifting of an automatic transmission are performed in the state in which the internal combustion engine is stopped and the torque of a rotating electrical machine is transmitted to the wheels.

In view of the above, a control device that controls a vehicle drive device in which an engagement device, a rotating electrical machine, and an automatic transmission are arranged in this order from an input side on a power transmission path connecting an input drivingly coupled to an internal combustion engine and an output drivingly coupled to a wheel includes an electronic control unit that is configured to, when starting of the internal combustion engine and downshifting are performed in a state in which the internal combustion engine is stopped, the engagement device is disengaged, and torque of the rotating electrical machine is transmitted to the wheel: engage the engagement device to increase a rotational speed of the internal combustion engine to a startable rotational speed, after the rotational speed of the internal combustion engine is increased to the startable rotational speed, ignite the internal combustion engine and then disengage the engagement device, after the ignition of the internal combustion engine, increase the rotational speed of the internal combustion engine toward a post-downshift synchronous rotational speed by torque of the internal combustion engine, after the disengagement of the engagement device, increase a rotational speed of the rotating electrical machine toward the post-downshift synchronous rotational speed to perform the downshifting of the automatic transmission, and engage the engagement device after completion of the downshifting, the startable rotational speed being a rotational speed at which the internal combustion engine is able to be started by ignition, and the post-downshift synchronous rotational speed being a rotational speed of the rotating electrical machine after completion of the downshifting in the case where the downshifting in which a speed ratio of the automatic transmission is changed to a higher one is performed.

According to the above characteristic configuration, the engagement device is disengaged after the engagement device is engaged and the rotational speed of the internal combustion engine is increased to the startable rotational speed. The rotational speed can therefore be changed for the downshifting with the rotating electrical machine being disconnected from the internal combustion engine. Since there is no inertia of the internal combustion engine, the rotational speed of the rotating electrical machine can be quickly made close to the post-downshift synchronous rotational speed and downshifting of the automatic transmission can be quickly completed. The torque of the rotating electrical machine having not subtracted therefrom the inertia torque for changing the rotational speeds of the internal combustion engine and the rotating electrical machine can be quickly transmitted to the wheel at the speed ratio after the downshift. After the rotational speed of the internal combustion engine is increased to the startable rotational speed and the internal combustion engine is ignited, the rotational speed of the internal combustion engine is increased toward the post-downshift synchronous rotational speed by the torque of the internal combustion engine itself. The engagement device can therefore be smoothly engaged after completion of the downshifting. After the engagement of the engagement device, the torque of the internal combustion engine can s be transmitted to the wheel at the speed ratio after the downshift. Large torque can therefore be transmitted to the wheel.

### BRIEF DESCRIPTION OF THE DRAWINGS

FIG. 1 is a schematic diagram of a vehicle drive device according to an embodiment.

FIG. 2 is a schematic diagram showing the inner configuration of an automatic transmission.

FIG. 3 is an operation table of the automatic transmission.

FIG. 4 is a block diagram showing the schematic configuration of a control device.

FIG. 5 is a flowchart illustrating a processing procedure of internal combustion engine start control.

FIG. 6 is a flowchart illustrating a processing procedure of start-shift parallel control.

FIG. 7 is a timing chart illustrating an example of the start-shift parallel control.

FIG. 8 is a timing chart illustrating a comparative example.

FIG. 9 is a schematic diagram of a vehicle drive device in another form.

FIG. 10 is a schematic diagram of a vehicle drive device in still another form.

### DETAILED DESCRIPTION OF EMBODIMENTS

A control device 1 according to an embodiment will be described. The control device 1 is a control device 1 that controls a vehicle drive device 3. The vehicle drive device 3 to be controlled is a drive device (hybrid vehicle drive device) for driving what is called a hybrid vehicle having an internal combustion engine EG and a rotating electrical machine MG as driving force sources for wheels W. In the present embodiment, the vehicle drive device 3 is a parallel hybrid vehicle drive device for driving a parallel hybrid vehicle.

In the following description, the expression “drivingly coupled” means two rotary elements being coupled so that they can transmit a driving force therebetween. This concept includes the state in which two rotary elements are coupled so as to rotate together and the state in which two rotary elements are coupled via one or more transmission members so that they can transmit a driving force therebetween via the one or more transmission members. Such transmission members include various members that transmit rotation at the same speed or at a shifted speed (e.g., a shaft, a gear mechanism, a belt, a chain, etc) and may include engagement devices that selectively transmit rotation and a driving force (e.g., a friction engagement device, a meshing engagement device, etc.),

The term “rotating electrical machine” is used as a concept including all of a motor (electric motor), a generator (electric generator), and a motor-generator that functions as both a motor and a generator as necessary.

Regarding the engagement state of a friction engagement element, the “engaged state” means the state in which the friction engagement element has a transfer torque capacity. The transfer torque capacity is the maximum torque the friction engagement element can transmit by friction, and the magnitude of the transfer torque capacity is determined in proportion to the pressure (engagement pressure) that presses a pair of engagement members (an input-side engagement member and an output-side engagement member) included in the friction engagement element against each other. This “engaged state” includes the “direct-coupling engaged state” in which there is no rotational speed difference (slipping) between the pair of engagement members and the “slip-engaged state” in which there is a rotational speed difference between the pair of engagement members. The “disengaged state” means that the friction engagement element does not have a transfer torque capacity, except for drag torque between the pair of engagement members.

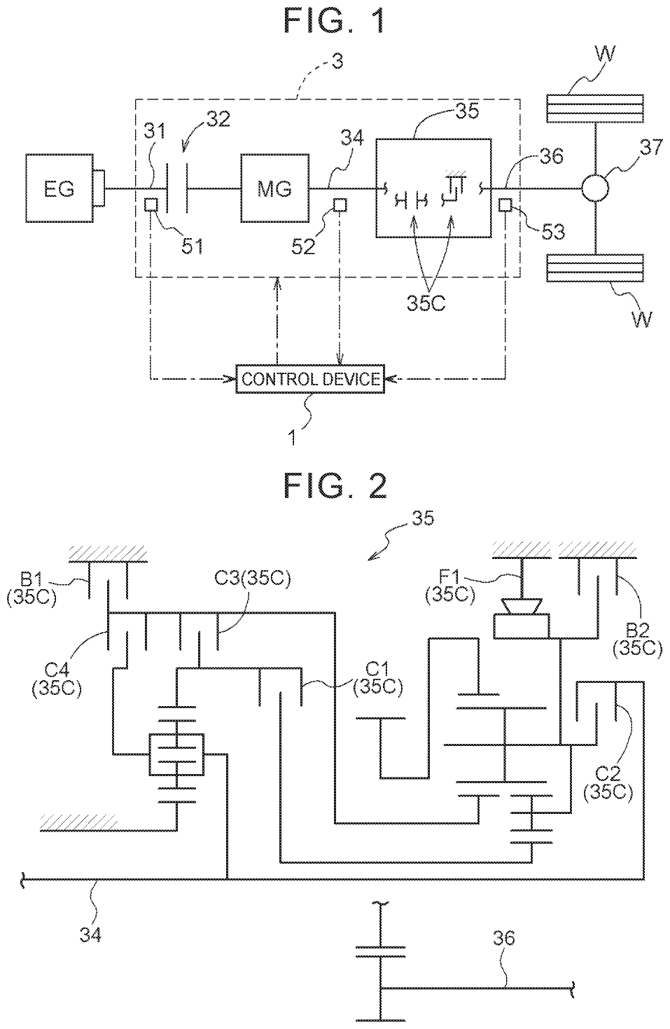

As shown in FIG. 1, in this vehicle drive device 3, a transmission engagement device 32, the rotating electrical machine MG, and an automatic transmission 35 are arranged in this order from the input member 31 side on a power transmission path connecting an input member 31 (input) drivingly coupled to the internal combustion engine EG and an output member 36 drivingly coupled to the wheels W. The rotating electrical machine MG and the automatic transmission 35 are coupled via a shift input member 34. Accordingly, in the present embodiment, the input member 31, the transmission engagement device 32, the rotating electrical machine MG, the shift input member 34, the automatic transmission 35, and the output member 36 (output) are arranged in this order from the internal combustion engine EG side along the power transmission path.

The input member 31 is drivingly coupled to the internal combustion engine EG. The internal combustion engine EG is a motor that is driven by fuel combustion in the engine to output power, such as, e.g., a gasoline engine, a diesel engine, or a gas turbine. The input member 31 is formed by, e.g., a shaft member (an input shaft). The input member 31 is drivingly coupled so as to rotate with an internal combustion engine output member (a crankshaft etc.) that is an output member of the internal combustion engine EG. The rotational speed of the input member 31 is therefore basically equal to the rotational speed Neg of the internal combustion engine EG. The input member 31 and the internal combustion engine output member may be directly coupled together or may be coupled together via other member(s) such as a damper. The input member 31 is drivingly coupled to the rotating electrical machine MG via the transmission engagement device 32.

The transmission engagement device 32 selectively couples the input member 31 and the rotating electrical machine MG. In other words, the transmission engagement device 32 can switch the state between the state in which the internal combustion engine EG and the rotating electrical machine MG are coupled together and the state in which the internal combustion engine EG and the rotating electrical machine MG are decoupled from each other. The transmission engagement device 32 thus functions as an internal combustion engine disconnection engagement device that disconnects the internal combustion engine EG from the vehicle drive device 3 including the rotating electrical machine MG and the automatic transmission 35. In the present embodiment, the transmission engagement device 32 is a friction engagement device, and for example, a wet multi-plate clutch etc. can be used as the transmission engagement device 32.

The rotating electrical machine MG includes a stator fixed to a case that is a non-rotary/member and a rotor rotatably supported radially inside the stator. The rotating electrical machine MG is connected to an electrical storage device via an inverter device. The rotating electrical machine MG is supplied with electric power from the electrical storage device to perform power running, or supplies electric power generated by the torque Teg of the internal combustion engine EG, the inertial force of the vehicle, etc. to the electrical storage device to store the electric power therein. The rotor of the rotating electrical machine MG is coupled the shift input member 34 so as to rotate therewith. In the present embodiment, the rotational speed Nin of the shift input member 34 is therefore equal to the rotational speed of the rotating electrical machine MG (the rotor). The shift input member 34 is formed by, e.g., a shaft member (a shift input shaft). The shift input member 34 that rotates with the rotor is drivingly coupled to the automatic transmission 35.

In the present embodiment, the automatic transmission 35 is a stepped automatic transmission. As shown in, e.g., FIG. 2, the automatic transmission 35 of the present embodiment includes a plurality of planetary gear mechanisms and a plurality of shift engagement devices 35C. In the present embodiment, the planetary gear mechanisms include a double-pinion type (or single-pinion type) first planetary gear unit and a Ravigneaux type second planetary gear unit. The shift engagement devices 35C include clutches C1, C2, C3, C4 and brakes B1, B2. In the present embodiment, the clutches C1, C2, C3, C4 and the brakes B1, B2 which form the shift engagement devices 35C are friction engagement devices, and for example, wet multi-plate clutches, wet multi-plate brakes, etc. can be used as the clutches C1, C2, C3, C4 and the brakes B1, B2. The shift engagement devices 35C may include one or more one-way clutches, and in this example, include a single one-way clutch F1.

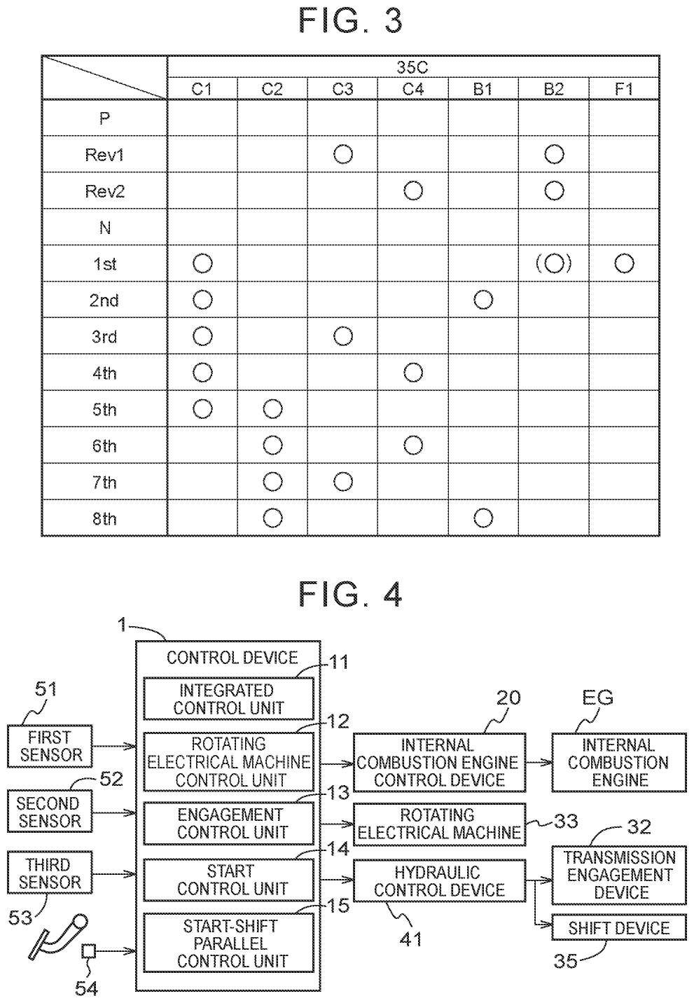

The automatic transmission 35 can selectively establish one of a plurality of shift speeds according to the engagement states of the clutches C1, C2, C3, C4 and the brakes B1, B2 (or the one-way clutch F1), based on, e.g., the operation table shown in FIG. 3. For example, the automatic transmission 35 establishes a first speed (1st) with the first clutch C1 and the second brake B2 being in the direct-coupling engaged state and the other shift engagement devices 35C being in the disengaged state. For example, the automatic transmission 35 establishes a second speed (2nd) with the first clutch C1 and the first brake B1 being in the direct-coupling engaged state and the other shift engagement devices 35C being in the disengaged state. The same applies to the other shift speeds (3rd to 8th). In FIG. 3, “(O)” represents the state in which negative torque is transmitted from the wheel W side, namely the state in which the shift engagement device 35C is engaged only when the engine brake is in operation or during regenerative braking.

The automatic transmission 35 shifts the rotational speed Nin of the shift input member 34 based on the speed ratio according to the established shift speed and transmits the shifted rotational speed to the output member 36. As used herein, the “speed ratio” refers to the ratio of the rotational speed Nin of the shift input member 34 to the rotational speed of the output member 36 and is calculated as the rotational speed Nin of the shift input member 34 divided by the rotational speed of the output member 36. That is, the higher the speed ratio is, the more the speed of rotation that is transmitted from the shift input member 34 to the output member 36 is reduced. The higher the speed ratio is, the more the torque that is transmitted from the shift input member 34 to the output member 36 is amplified, and the amplified torque is transmitted to the output member 36.

As shown in FIG. 1, the output member 36 is drivingly coupled to the pair of wheels W, namely the right and left wheels W, via a differential gear unit 37. The torque transmitted to the output member 36 is distributed and transmitted to the two wheels W, namely the right and left wheels W, via the differential gear unit 37. The vehicle drive device 3 can thus transmit the torque of one or both of the internal combustion engine EG and the rotating electrical machine MG to the wheels W to move the vehicle. The output member 36 is formed by, e.g., a shaft member (an output shaft), a gear mechanism (an output gear), etc.

The control device 1 functions as a core that controls the operation of each part of the vehicle drive device 3 described above. In the present embodiment, as shown in FIG. 4, the control device 1 includes an integrated control unit 11, a rotating electrical machine control unit 12, an engagement control unit 13, a start control unit 14, and a start-shift parallel control unit 15. Each of these functional units is comprised of software (a program) stored in a storage medium such as a memory or hardware such as a separate arithmetic circuit or is comprised of both the software and the hardware. The functional units are configured so that they can transmit and receive information to and from each other. The control device 1 is configured so that it can obtain information on the detection results of various sensors (first to fourth sensors 51 to 54) included in each part of the vehicle equipped with the vehicle drive device 3.

The first sensor 51 detects the rotational speed of the input member 31 and a member that rotates with the input member 31 (e.g., the internal combustion engine EG). The second sensor 52 detects the rotational speed of the shift input member 34 and a member that rotates with the shift input member 34 (e.g., the rotating electrical machine MG). The third sensor 53 detects the rotational speed of the output member 36 or the rotational speed of a member that rotates synchronously with the output member 36 (e.g., the wheels W). As used herein, “rotate synchronously” refers to rotating at a rotational speed proportional to a reference rotational speed. The control device 1 can calculate the vehicle speed based on the detection result of the third sensor 53. The fourth sensor 54 detects the accelerator operation amount. The control device 1 can calculate request driving force (request torque) requested by the driver, based on the detection result of the fourth sensor 54. The control device 1 is configured so that it can also obtain information on the brake operation amount, the amount of electricity stored in the electrical storage device, etc.

The integrated control unit 11 performs control to integrate various kinds of control (torque control, rotational speed control, engagement control, etc.) that are performed on the internal combustion engine EG, the rotating electrical machine MG, the transmission engagement device 32, the automatic transmission 35 (the shift engagement devices 35C), etc. for the vehicle as a whole. The integrated control unit 11 calculates vehicle request torque requested to drive the vehicle (the wheels W), based on the sensor detection information (mainly the information on the accelerator operation amount and the vehicle speed).

The integrated control unit 11 determines the drive mode based on the sensor detection information (mainly the information on the accelerator operation amount, the vehicle speed, and the amount of electricity stored in the electrical storage device). In the present embodiment, the drive modes that can be selected by the integrated control unit 11 include an electric drive mode (hereinafter referred to as the “EV mode”) and a hybrid drive mode (hereinafter referred to as the “HEV mode”). The EV mode is a drive mode in which the internal combustion engine EG is disconnected from the wheels W and the torque Tmg of the rotating electrical machine MG is transmitted to the wheels W to move the vehicle. The HEV mode is a drive mode in which the torque of both the internal combustion engine EG and the rotating electrical machine MG is transmitted to the wheels W to move the vehicle.

The integrated control unit 11 determines output torque requested for the internal combustion engine EG (internal combustion engine request torque) and output torque requested for the rotating electrical machine MG (rotating electrical machine request torque) based on the determined drive mode, the sensor detection information, etc. The integrated control unit 11 determines the engagement state of the transmission engagement device 32, the target shift speed to be established by the automatic transmission 35, etc. based on the determined drive mode, the sensor detection information, etc.

In the present embodiment, the control device 1 (the integrated control unit 11) controls the operating point (the output torque and the rotational speed) of the internal combustion engine EG via an internal combustion engine control device 20. The internal combustion engine control device 20 can switch the control for the internal combustion engine EG between torque control and rotational speed control according to the traveling state of the vehicle. The torque control for the internal combustion engine EG is the control in which a command of target torque is sent to the internal combustion engine EG to control the output torque of the internal combustion engine EG so that the output torque follows the target torque. The rotational speed control for the internal combustion engine EG is the control in which a command of a target rotational speed is sent to the internal combustion engine EG and the output torque is determined so that the rotational speed Neg of the internal combustion engine EG follows the target rotational speed.

The rotating electrical machine control unit 12 controls the operating point (the output torque and the rotational speed) of the rotating electrical machine MG. The rotating electrical machine control unit 12 can switch control for the rotating electrical machine MG between torque control and rotational speed control according to the traveling state of the vehicle. The torque control for the rotating electrical machine MG is the control in which a command of target torque is sent to the rotating electrical machine MG to control the output torque of the rotating electrical machine MG so that the output torque follows the target torque. The rotational speed control for the rotating electrical machine MG is the control in which a command of a target rotational speed Nt is sent to the rotating electrical machine MG and the output torque is determined so that the rotational speed of the rotating electrical machine MG follows the target rotational speed Nt.

The engagement control unit 13 controls the engagement state of the transmission engagement device 32 and the engagement states of the plurality of shift engagement devices 35C (C1, C2, C3, C4, B1, B2) included in the automatic transmission 35. In the present embodiment, the transmission engagement device 32 and the plurality of shift engagement devices 35C are hydraulically driven friction engagement devices. The engagement control unit 13 controls the engagement states of the transmission engagement device 32 and the shift engagement devices 35C by controlling via a hydraulic control device 41 the oil pressures to be supplied to the transmission engagement device 32 and the shift engagement devices 35C.

The engagement pressure of each engagement device changes in proportion to the magnitude of the oil pressure being supplied to that engagement device. Accordingly, the magnitude of the transfer torque capacity of each engagement device changes in proportion to the magnitude of the oil pressure that is supplied to that engagement device. The engagement state of each engagement device is controlled to one of the direct-coupling engaged state, the slip-engaged state, and the disengaged state according to the oil pressure that is supplied thereto. The hydraulic control device 41 includes a hydraulic control valve (a linear solenoid valve etc.) for adjusting the oil pressure of hydraulic oil that is supplied from an oil pump (not shown). For example, the oil pump may be a mechanical pump that is driven by the input member 31, the shift input member 34, etc., an electric pump that is driven by a pump rotating electrical machine, etc. The hydraulic control device 41 adjusts the opening amount of the hydraulic control valve according to an oil pressure command from the engagement control unit 13 to supply an oil pressure according to the oil pressure command to each engagement device.

The engagement control unit 13 controls the engagement state of the transmission engagement device 32 so as to establish the drive mode determined by the integrated control unit 11. For example, the engagement control unit 13 controls the transmission engagement device 32 to the disengaged state when establishing the EV mode and controls the transmission engagement device 32 to the direct-coupling engaged state when establishing the HEV mode. The engagement control unit 13 controls the transmission engagement device 32 to the slip-engaged state during transition from the EV mode to the HEV mode.

The engagement control unit 13 controls the engagement states of the plurality of shift engagement devices 35C (C1, C2, C3, C4, B1, B2) so as to establish the target shift speed determined by the integrated control unit 11. The engagement control unit 13 controls two of the shift engagement devices 35C according to the target shift speed to the direct-coupling engaged state and controls all of the other shift engagement devices 35C to the disengaged state (see FIG. 3). When the target shift speed is changed during traveling of the vehicle, the engagement control unit 13 controls a specific shift engagement device 35C from the direct-coupling engaged state to the disengaged state and controls a different specific shift engagement device 35C from the disengaged state to the engaged state, based on the difference between the shift engagement devices 35C that should be in the direct-coupling engaged state at the original target shift speed and the shift engagement devices 35C that should be in the direct-coupling engaged state at the changed target shift speed. The operation of changing the shift engagement devices 35C to be controlled to the direct-coupling engaged state as described above is called a shift operation. The “shift operation” includes “upshifting” in which the speed ratio is changed to a lower one and “downshifting” in which the speed ratio is changed to a higher one.

In the following description, the “disengage-side engagement device 35R” refers to the shift engagement device 35C that is switched from the engaged state to the disengaged state during the shift operation, and the “engage-side engagement device 35A” refers to the shift engagement device 35C that is switched from the disengaged state to the engaged state (is engaged) during the shift operation. The “direct-coupling maintained engagement device 35S” refers to the shift engagement device 35C that should be in the direct-coupling engaged state at both of the original target shift speed and the changed target shift speed and that is kept in the direct-coupling engaged state during the shift operation. Referring to FIG. 3, for example, in the case where the shift operation (downshifting) from the fourth speed (4th) to the third speed (3rd) is performed, the first clutch C1 is the direct-coupling maintained engagement device 35S, the fourth clutch C4 is the disengage-side engagement device 35R, and the third clutch C3 is the engage-side engagement device 35R. For example, in the shift operation (upshifting) from the fifth speed (5th) to the sixth speed (6th), the second clutch C2 is the direct-coupling maintained engagement device 35S, the first clutch C1 is the disengage-side engagement device 35R, and the fourth clutch C4 is the engage-side engagement device 35A. The same applies to the shift operations between other shift speeds.

In the case where downshifting is not involved in transition from the EV mode to the HEV mode, the start control unit 14 performs normal internal combustion engine start control. In the EV mode, the internal combustion engine EG is stopped, the transmission engagement device 32 is disengaged, and the torque Tmg of the rotating electrical machine MG is transmitted to the wheels W. If, in this state, a mode transition request to the HEV mode (a request to start the internal combustion engine) is detected due to, e.g., increased vehicle request torque resulting from driver's accelerator operation or a reduced amount of electricity stored in the electrical storage device, the start control unit 14 performs the internal combustion engine start control.

In the present embodiment, in the normal internal combustion engine start control, the start control unit 14 cooperates with the engagement control unit 13 to switch one of the plurality of shift engagement devices 35C to the slip-engaged state. The shift engagement device 35C to be switched to the slip-engaged state is the shift engagement device 35C that is less likely to be the direct-coupling maintained engagement device 35S (i.e., that is more likely to be the disengage-side engagement device 35R) on the assumption that the shift operation is performed in this state. This is advantageous in that the shift operation is allowed to proceed quickly in the case where a shift request is detected during the internal combustion engine start control. In this example, the start control unit 14 switches the shift engagement device 35C, which is not the shift engagement device 35C (in this example, the first clutch C1 or the second clutch C2) that is more likely to be the direct-coupling; maintained engagement device 35S, to the slip-engaged state according to the shift speed at the time the internal combustion engine start control is started.

In the internal combustion engine start control, the start control unit 14 cooperates with the rotating electrical machine control unit 12 to increase the rotational speed of the rotating electrical machine MG (the rotational speed Nin of the shift input member 34) by the rotational speed control for the rotating electrical machine MG. For example, the start control unit 14 increases the rotational speed of the rotating electrical machine MG to a rotational speed higher than a synchronous rotational speed by the rotational speed control for the rotating electrical machine MG The synchronous rotational speed is the speed determined according to the speed ratio of the current shift speed and the rotational speed of the output member 36 (or the rotational speed of the wheels W that rotates synchronously with the output member 36). Specifically, the synchronous rotational speed is calculated by multiplying the rotational speed of the output member 36 by the speed ratio of the current shift speed. The start control unit 14 sets the target rotational speed Nt in the rotational speed control for the rotating electrical machine MG to a rotational speed higher than the synchronous rotational speed by a predetermined differential rotational speed to increase the rotational speed of the rotating electrical machine MG to a rotational speed higher than the synchronous rotational speed. This differential rotational speed is determined in advance in view of the rotational speed difference that allows the disengage-side engagement device 35R to be stably switched to the slip-engaged state. This differential rotational speed can be set as appropriate within the range of, e.g., 100 to 300 [rpm] etc.

Moreover, in the internal combustion engine start control, the start control unit 14 cooperates with the engagement control unit 13 to switch the transmission engagement device 32 to the slip-engaged state. The start control unit 14 thus increases the rotational speed of the internal combustion engine EG by the torque Tmg of the rotating electrical machine MG which is transmitted from the rotating electrical machine MG side toward the internal combustion engine EG side via the transmission engagement device 32 in the slip-engaged state. After the rotational speed Neg of the internal combustion engine EG becomes equal to or higher than a startable rotational speed Nig, the start control unit 14 cooperates with the internal combustion engine control device 20 to start the internal combustion engine EG by ignition. The startable rotational speed Nig is the rotational speed at which the internal combustion engine EG can initiate (start) self-sustaining operation by ignition. In the present embodiment, in the normal internal combustion engine start control, the internal combustion engine EG is started with the disengage-side engagement device 35R being in the slip-engaged state. This can prevent torque fluctuations during the first combustion of the internal combustion engine EG from being transmitted as they are to the wheels W. Shock associated with starting of the internal combustion engine EG (start shock) can thus be reduced.

In the case where downshifting is involved in transition from the EV mode to the HEV mode, the start-shift parallel control unit 15 performs start-shift parallel control. Control different from the normal internal combustion engine start control described above is performed in the start-shift parallel control. The start-shift parallel control is the control that is performed when starting of the internal combustion engine EG and downshifting of the automatic transmission 35 are performed in the state where the internal combustion engine EG is stopped, the transmission engagement device 32 is disengaged, and the torque Tmg of the rotating electrical machine MG is transmitted to the wheels W, namely in the EV mode. In this example, the rotational speed Neg of the internal combustion engine EG is changed in order to start the internal combustion engine, and at the same time, the engagement pressures of the shift engagement devices 35C are changed in order to downshift the automatic transmission 35. The start-shift parallel control unit 15 cooperates with the internal combustion engine control device 20, the rotating electrical machine control unit 12, and the engagement control unit 13 to perform the start-shift parallel control. In this control, the start-shift parallel control unit 15 engages the transmission engagement device 32, and after the rotational speed Neg of the internal combustion engine EG becomes equal to or higher than the startable rotational speed Nig, disengages the transmission engagement device 32 to disconnect the internal combustion engine EG so as to cause a change in rotation only by the rotating electrical machine MG, and then downshifts the automatic transmission 35. The downshifting is thus quickly completed, so that the torque Tmg of the rotating electrical machine MG can be transmitted to the wheels W at the speed ratio after the downshift. After ignition at the startable rotational speed Nig or higher, the rotational speed Neg of the internal combustion engine EG is increased toward a post-downshift synchronous rotational speed Na by its own torque and is synchronized with the post-downshift synchronous rotational speed Na. Thereafter, the start-shift parallel control unit 15 engages the transmission engagement device 32. After the transmission engagement device 32 is engaged, the torque Teg of the internal combustion engine EG can also be transmitted to the wheels W at the speed ratio after the downshift. Larger torque can thus be transmitted to the wheels W.

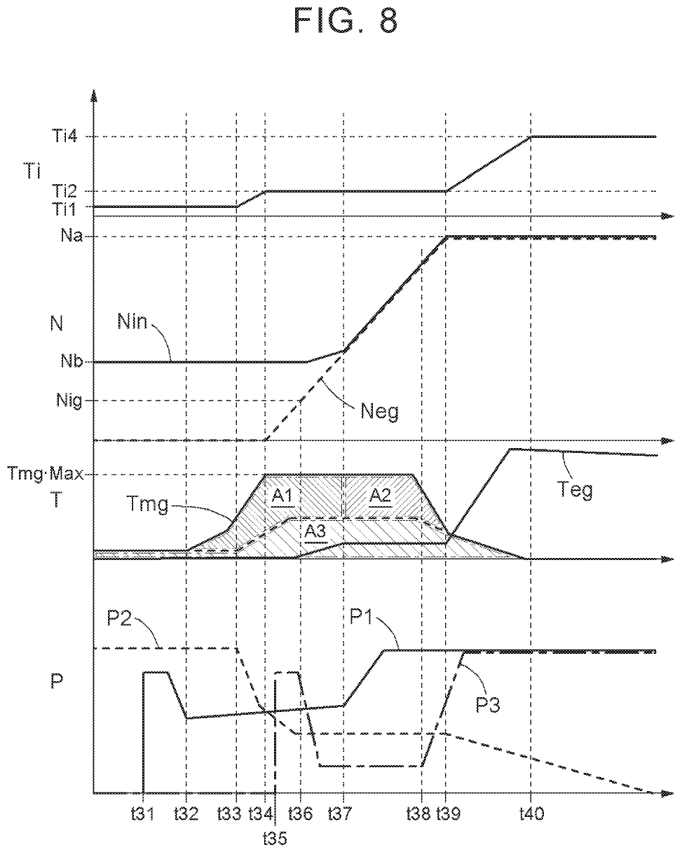

A comparative example of the start-shift parallel control of the present embodiment will be described. In the comparative example, in the case where the start control for the internal combustion engine EG and downshifting of the automatic transmission 35 are performed, downshifting is performed with the transmission engagement device 32 kept in the engaged state after the transmission engagement device 32 is engaged and the internal combustion engine EG is started, FIG. 8 is a timing chart of the comparative example. In this timing chart, “Ti” represents shift input transmission torque that is transmitted from the rotating electrical machine MG and the internal combustion engine EG, which are driving force sources for the wheels W, to the shift input member 34. “N” represents the rotational speed, and in this example, indicates the rotational speed Nin of the shift input member 34 (the rotating electrical machine MG) and the rotational speed Neg of the internal combustion engine EG. “T” represents torque, and in this example, indicates the torque Tmg of the rotating electrical machine MG and the torque Teg of the internal combustion engine EG. “P” represents the engagement pressure of the engagement device, and in this example, indicates the engagement pressure P1 of the transmission engagement device 32, the engagement pressure P2 of the disengage-side engagement device 35R, and the engagement pressure P3 of the engage-side engagement device 35A. In FIG. 8, an oil pressure command is shown as the engagement pressure of each engagement device.

As shown in FIG. 8, in the comparative example, in the case where starting of the internal combustion engine EG and downshifting of the automatic transmission 35 are performed in the EV mode, preparation for engagement of the transmission engagement device 32 is first started (t31). In this example, the shift input transmission torque Ti at this time is relatively small torque Ti1. Thereafter, the rotating electrical machine MG is controlled by the rotational speed control in which the rotational speed Nin of the shift input member 34 is controlled to follow the target rotational speed Nt. At this time, the rotating electrical machine MG is controlled with a pre-shift synchronous rotational speed Nb being the target rotational speed Nt. The pre-shift synchronous rotational speed Nb is the speed determined according to the speed ratio of the current shift speed before downshift and the rotational speed of the output member 36 (or the rotational speed of the wheels W that rotate synchronously with the output member 36). As the engagement pressure P1 of the transmission engagement device 32 gradually increases and the transmission engagement device 32 starts to be slip-engaged (t32), the torque that is transmitted toward the internal combustion engine EG side via the transmission engagement device 32 increases. The torque Tmg of the rotating electrical machine MG therefore increases accordingly, but the shift input transmission torque Ti (=Ti1) is maintained.

Thereafter, the engagement pressure P2 of the disengage-side engagement device 35R is reduced (t33). The disengage-side engagement device 35R is kept in the slip-engaged state during the period from the time the rotational speed Nin of the shift input member 34 starts to change for downshifting until the rotational speed Nin reaches the post-downshift synchronous rotational speed Na (t39). As the transmission torque increases due to the slip engagement of the transmission engagement device 32, the rotational speed Neg of the internal combustion engine EG starts to increase (t34). In this example, the torque Tmg of the rotating electrical machine MG has reached its maximum torque Tmg·Max at this time. However, since only the torque A3, which is the torque Tmg minus the internal combustion engine start torque A1 for increasing the rotational speed Neg of the internal combustion engine EG, can be transmitted to the wheels W, the shift input transmission torque Ti remains at Ti2.

Next, preparation for engagement of the engage-side engagement device 35A is started (t35). Thereafter, the internal combustion engine EG is started by ignition When the rotational speed Neg of the internal combustion engine EG becomes equal to or higher than the startable rotational speed Nig. The torque leg of the internal combustion engine EG thus starts to increase (t36). The rotational speed Neg of the internal combustion engine EG continues to increase. When the rotational speed Neg of the internal combustion engine EG is synchronized with the rotational speed Nin of the shift input member 34 (t37), the transmission engagement device 32 is switched to the direct-coupling engaged state. Thereafter, the engagement pressure P1 of the transmission engagement device 32 is increased toward a full engagement pressure for maintaining the direct-coupling engaged state. The rotational speeds Neg, Nin of the internal combustion engine EG and the shift input member 34 (the rotating electrical machine MG) which rotate together are also increased toward the post-downshift synchronous rotational speed Na by the torque Tmg of the rotating electrical machine MG (t37 to t39). In this example, the torque Tmg of the rotating electrical machine MG is still the maximum torque Tmg·Max during this period. However, since only the torque A3, which is the torque Tmg minus the shift rotation change torque A2 for increasing the rotational speeds Neg, Nin of the internal combustion engine EG and the shift input member 34 (the rotating electrical machine MG), can be transmitted to the wheels W, the shift input transmission torque Ti still remains at Ti2.

When the rotational speeds Neg, Nin of the internal combustion engine EG and the shift input member 34 (the rotating electrical machine MG) have increased to the post-downshift synchronous rotational speed Na minus a set rotational speed difference (t38), the engagement pressure P3 of the engage-side engagement device 35A starts to be increased. The engage-side engagement device 35A is switched to the direct-coupling engaged state when the rotational speeds Neg, Nin of the internal combustion engine EG and the shift input member 34 (the rotating electrical machine MG) are synchronized with the post-downshift synchronous rotational speed Na (t39). The drive mode thus transitions to the hybrid mode. In this example, the rotational speed control for the rotating electrical machine MG is terminated at this time. Thereafter, the engagement pressure P3 of the engage-side engagement device 35A is increased toward a full engagement pressure for maintaining the direct-coupling engaged state, and the engagement pressure P2 of the disengage-side engagement device 35R that has been in the slip-engaged state is gradually reduced toward a full disengagement pressure. After the engage-side engagement device 35A is switched to the direct-coupling engaged state, the torque Teg of the internal combustion engine EG is increased (t39 to t40). The shift input transmission torque Ti thus increases from Ti2 to Ti4. In this example, the torque Tmg of the rotating electrical machine MG is reduced with the increase in torque Teg of the internal combustion engine EG Starting of the internal combustion engine EG and downshifting of the automatic transmission 35 are thus completed, and the torque Teg of the internal combustion engine EG is then transmitted to the wheels W to move the vehicle. In this state, the rotating electrical machine MG generates electricity or performs power running as necessary to provide torque assistance.

As described above, in the control of the comparative example, regarding the shift input transmission torque Ti that is transmitted to the shift input member 34, only the torque Ti2 that is significantly smaller than the torque corresponding to the maximum torque Tmg·Max of the rotating electrical machine MG can be transmitted to the shift input member 34 until both starting of the internal combustion engine EG and downshifting of the automatic transmission 35 are completed, which may make the driver feel that acceleration of the vehicle is slow. However, as described below, large torque can be quickly transmitted to the wheels W by performing the start-shift parallel control according to the present embodiment.

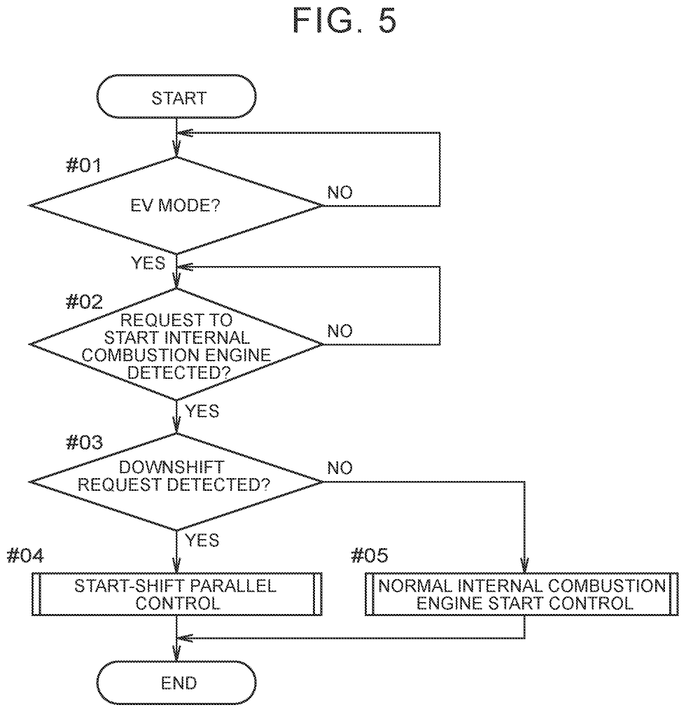

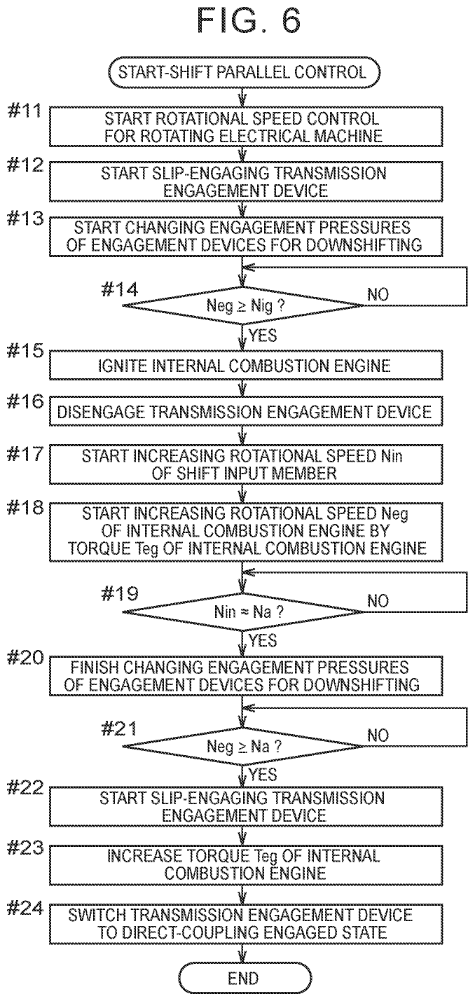

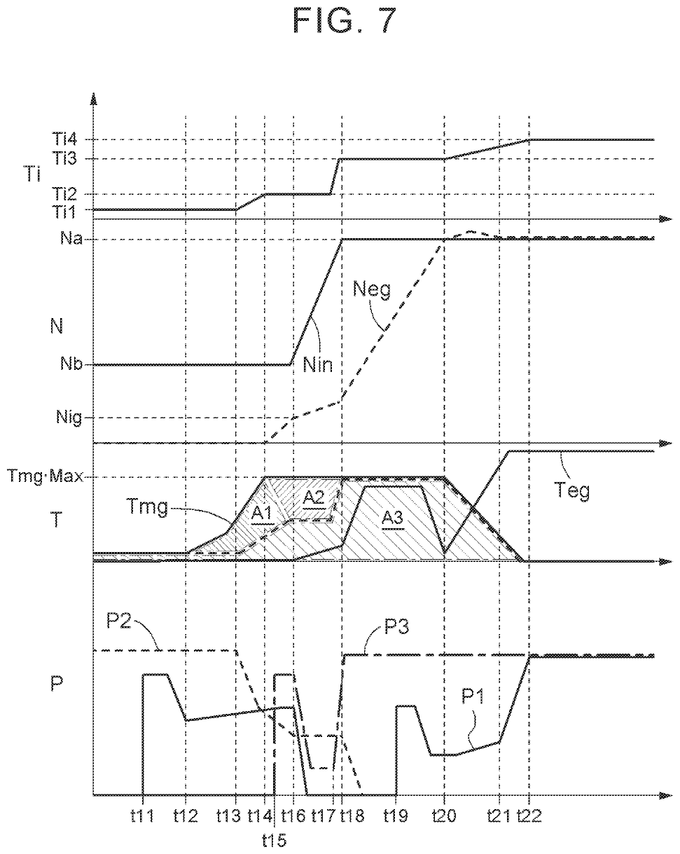

FIG. 5 is a flowchart illustrating the processing procedure of the internal combustion engine start control. FIG. 6 is a flowchart illustrating the processing procedure of the start-shift parallel control according to the present embodiment. FIG. 7 is a timing chart illustrating an example of the start-shift parallel control. The same indexes as those of FIG. 8 are shown in the timing chart of FIG. 7.

As shown in FIG. 5, the control device 1 determines whether there is a request to downshift the automatic transmission 35 (#3) in the case where there is a request to start the internal combustion engine EG (#2: Yes) during the EV mode in which the internal combustion engine EG is stopped, the transmission engagement device 32 is disengaged, and the torque Tmg of the rotating electrical machine MG is transmitted to the wheels W (#1). If both a request to start the internal combustion engine EG and a request for downshifting are detected, the control device 1 performs the start-shift parallel control (#4). If only a request to start the internal combustion engine EG is detected and no request for downshifting is detected, the control device 1 performs the normal internal combustion engine start control described above (#5).

An example of the start-shift parallel control according to the present embodiment will be described by using the flowchart of FIG. 6 and the timing chart of FIG. 7. Generally, in this start-shift parallel control, the transmission engagement device 32 is first engaged to increase the rotational speed of the internal combustion engine EG to the startable rotational speed Nig. After the rotational speed of the internal combustion engine EG is increased to the startable rotational speed Nig, the internal. combustion engine EG is ignited and the transmission engagement device 32 is then disengaged. After the ignition of the internal combustion engine EG, the rotational speed of the internal combustion engine EG is increased toward the post-downshift synchronous rotational speed Na by the torque Teg of the internal combustion engine EG After the transmission engagement device 32 is disengaged, the rotational speed of the rotating electrical machine MG is increased toward the post-downshift synchronous rotational speed Na to downshift the automatic transmission 35. After the downshifting is completed, the transmission engagement device 32 is engaged.

Specifically, in the start-shift parallel control, preparation for engagement of the transmission engagement device 32 is started (t11). In this example, the shift input transmission torque Ti at this time is relatively small torque Ti1. Thereafter, the rotating electrical machine MG is controlled by the rotational speed control in which the rotational speed. Nin of the shift input member 34 is controlled to follow the target rotational speed Nt (#11). At this time, the rotating electrical machine MG is controlled with the pre-shift synchronous rotational speed Nb being the target rotational speed Nt. The engagement pressure P1 of the transmission engagement device 32 gradually increases and the transmission engagement device 32 starts to be slip-engaged (t12, #12). Since the torque that is transmitted toward the internal combustion engine EG side via the transmission engagement device 32 thus increases, the torque Tmg of the rotating electrical machine MG increases accordingly, but the shift input transmission torque Ti (=Ti1) is maintained.

Thereafter, the engagement pressures f the shift engagement devices 35C of the automatic transmission 35 start to be changed for downshifting (#13). Specifically, the engagement pressure P2 of the disengage-side engagement device 35R starts to be reduced (t13). The disengage-side engagement device 35R is kept in the slip-engaged state during the period from the time the rotational speed Nin of the shift input member 34 starts to be increased for downshifting until the rotational speed Nin reaches the post-downshift synchronous rotational speed Na (t18). The period during which the engagement pressure P2 of the disengage-side engagement device 35R is reduced in the period in which the engage-side engagement device 35A is switched to the slip-engaged state (t13 to t17), namely in the period during which the disengage-side engagement device 35R transmits torque to the wheels W, corresponds to a preparation period for downshifting. As the transmission increases due to the slip engagement of the transmission engagement device 32, the rotational speed Neg of the internal combustion engine EG starts to increase (t14). In this example, the engagement pressure of the disengage-side engagement device 35R is reduced as preparation for downshifting during a period that overlaps the period in which the transmission engagement device 32 is engaged to increase the rotational speed Neg of the internal combustion engine EG to the startable rotational speed Nig. At this time, the torque Tmg of the rotating electrical machine MG has readied the maximum torque Tmg·Max. However, since only the torque A3, namely the torque Tmg minus the internal combustion engine start torque A1 for increasing the rotational speed Neg of the internal combustion engine EG, can be transmitted to the wheels W, the shift input transmission torque Ti remains at Ti2.

Next, preparation for engagement of the engage-side engagement device 35A is started (t15). Thereafter, when the rotational speed Neg of the internal combustion engine EG becomes equal to or higher than the startable rotational speed Nig (#14, t16), the internal combustion engine EG is started by ignition (#15). In this start-shift parallel control, unlike the above comparative example, after the rotational speed of the internal combustion engine EG increases to the startable rotational speed Nig, the engagement pressure P1 of the transmission engagement device 32 is reduced and the transmission engagement device 32 is disengaged (#16, t16). The rotational speed Nin of the shift input member 34 (the rotating electrical machine MG) is increased toward the post-downshift synchronous rotational speed Na by the torque Tmg of the rotating electrical machine MG (#17, t16 to t18). At this time, since the transmission engagement device 32 is in the disengaged state, the rotational speed Nin of the shift input member 34 can be increased for downshifting with the shift input member 34 and the rotating electrical machine MG being disconnected from the internal combustion engine EG. Since there is no inertia of the internal combustion engine EG, the rotational speed Nin of the shift input member 34 can be quickly made close to the post-downshift synchronous rotational speed Na and downshifting of the automatic transmission 35 can be quickly completed. The torque Tmg of the rotating electrical machine MG is the maximum torque Tmg·Max even during this downshifting. However, since only the torque A3, which is the torque Tmg minus the shift rotation change torque A2 for increasing the rotational speed Nin of the shift input member 34 and the rotating electrical machine MG, can be transmitted to the wheels W, the shift input transmission torque Ti still remains at Ti2.

When the rotational speed Nin of the shift input member 34 (the rotating electrical machine MG) has increased to the post-downshift synchronous rotational speed Na minus a set rotational speed difference, the engagement pressure P3 of the engage-side engagement device 35A starts to be increased (t17). The engage-side engagement device 35A is switched to the direct-coupling engaged state when the rotational speed Nin of the shift input member 34 (the rotating electrical machine MG) is synchronized with the post-downshift synchronous rotational speed Na (#19: Yes, t18). Thereafter, the engagement pressure P3 of the engage-side engagement device 35A is further increased toward a full engagement pressure for maintaining the direct-coupling engaged state, arid the engagement pressure P2 of the disengage-side engagement device 35R that has been in the slip-engaged state is gradually reduced toward a full disengagement pressure. The engagement pressures of the engagement devices of the automatic transmission 35 thus finish changing for downshifting (#20) and downshifting of the automatic transmission 35 is completed. In this example, the rotational speed control for the rotating electrical machine MG is terminated at this time, and the torque control in which the torque Tmg of the rotating electrical machine MG is controlled to follow the target torque is started. That is, in the present embodiment, the rotational speed control in which the rotational speed of the rotating electrical machine MG is controlled to follow the target rotational speed Nt is performed during the period from the time the transmission engagement device 32 starts to be engaged in order to increase the rotational speed of the internal combustion engine EG (t12) until downshifting is completed (t18). The rotational speed of the rotating electrical machine MG can thus be stabilized in accordance with the target rotational speed Nt regardless of torque fluctuations due to engagement of the transmission engagement device 32 and torque fluctuations due to an increase in rotational speed of the rotating electrical machine MG for downshifting. The traveling state of the vehicle during this period can therefore be stabilized.

After the rotational speed Nin of the shift input member 34 (the rotating electrical machine MG) finishes changing, the maximum torque Tmg·Max of the rotating electrical machine MG from which the shift rotation change torque A2 for increasing the rotational speed Nin of the shift input member 34 and the rotating electrical machine MG has not been subtracted can be transmitted to the shift input member 34. The shift input transmission torque Ti therefore increases from Ti2 to Ti3. As described above, according to the start-shift parallel control of the present embodiment, the torque Tmg of the rotating electrical machine MG from which the inertia torque for changing the rotational speeds of the internal combustion engine EG and the rotating electrical machine MG has not been subtracted can be quickly transmitted to the wheels W at the speed ratio after downshift.

After the ignition of the internal combustion engine EG, the torque Teg of the internal combustion engine EG starts to increase. The rotational speed Neg of the internal combustion engine EG is increased toward the post-downshift synchronous rotational speed Na by the torque Teg of the internal combustion engine EG (#18, t16 to t20). Accordingly, in this example, the rotational speed of the internal combustion engine EG is increased toward the post-downshift synchronous rotational speed Na by the torque Teg of the internal combustion engine EG even after downshifting is completed (t18 to t20). The rotational speed. Neg of the internal combustion engine EG is thus matched (synchronized) with the post-downshift synchronous rotational speed Na by the torque Teg of the internal combustion engine EG; whereby the transmission engagement device 32 can be smoothly engaged after downshifting is completed. Preparation for engagement of the transmission engagement device 32 that has been switched to the disengaged state is started again in this period (t19).

In the present embodiment, the transmission engagement device 32 is engaged after the rotational speed of the internal combustion engine EG becomes higher than the post-downshift synchronous rotational speed Na after completion of downshifting. Negative torque can thus be restrained from being transmitted to the wheel W side when the transmission engagement device 32 is engaged. Accordingly, shock in the deceleration direction can be restrained from occurring in the vehicle during acceleration. The rotational speed control for the internal combustion engine EG is therefore performed so that the rotational speed Neg of the internal combustion engine EG approaches the post-downshift synchronous rotational speed Na after the rotational speed Neg becomes higher than the post-downshift synchronous rotational speed Na. In this case, when the rotational speed Neg of the internal combustion engine EG approaches the post-downshift synchronous rotational speed Na, the torque Teg of the internal combustion engine EG is reduced to gradually change the rotational speed Neg of the internal combustion engine EG (t20), and the rotational speed Neg is thus made to asymptotically approach the post-downshift synchronous rotational speed Na (t20 to t21). After the rotational speed Neg of the internal combustion engine EG becomes higher than the post-downshift synchronous rotational speed Na (#21: Yes, t20), the engagement pressure P1 of the transmission engagement device 32 is gradually increased to start slip engagement of the transmission engagement device 32 (#22, t20 to t21). The rotational speed Neg of the internal combustion engine EG is thus synchronized with the post-downshift synchronous rotational speed Na and the transmission engagement device 32 is switched to the direct-coupling engaged state (t21). As described above, in the present embodiment, at the time engagement of the transmission engagement device 32 that has been switched to the disengaged state is started, downshifting has been completed and the engage-side engagement device 35A has been in the direct-coupling engaged state. Accordingly, in the present embodiment, the transmission engagement device 32 is switched to the direct-coupling engaged state after the engage-side engagement device 35A is switched to the direct-coupling engaged state by downshifting. In this example, the torque Teg of the internal combustion engine EG is increased (#23) when slip engagement of the transmission engagement device 32 is started (#22, t20). The shift input transmission torque Ti therefore gradually increases from Ti3 to Ti4 (t20 to t22). In this example, the torque Tmg of the rotating electrical machine MG is reduced with an increase in torque Teg of the internal combustion engine EG,

In the present embodiment, the rotating electrical machine MG outputs the maximum torque Tmg·Max during the period from the time the rotational speed of the internal combustion engine EG starts to increase by engagement of the transmission engagement device 32 (t14) until the torque Teg of the internal combustion engine EG starts to be transmitted to the output member 36 by engagement of the transmission engagement device 32 after completion of downshifting (t20). This can reduce the period from the time the rotational speed of the internal combustion engine EG is increased to the startable rotational speed Nig until the rotational speed of the rotating electrical machine MG is then increased toward the post-downshift synchronous rotational speed Na and downshifting of the automatic transmission 35 is completed. After completion of downshifting, the torque Ti3 corresponding to the maximum torque Tmg·Max of the rotating electrical machine MG can be transmitted to the shift input member 34.

Thereafter, the engagement pressure P1 of the transmission engagement device 32 is increased to a full engagement pressure for maintaining the direct-coupling engaged state (#24, t22). The drive mode thus transitions to the hybrid mode. After the transmission engagement device 32 is engaged, the torque Teg of the internal combustion engine EG can also be transmitted to the wheels W at the speed ratio after downshift. Large torque Ti4 can therefore be transmitted to the wheels W. In this state, the rotating electrical machine MG generates electricity or performs power running as necessary to provide torque assistance. The start-shift parallel control is thus terminated.

### Other Embodiments

(1) The above embodiment is described with respect to the configuration in which the rotational speed control in which the rotational speed of the rotating electrical machine MG is controlled to follow the target rotational speed Nt is performed during the period from the time the transmission engagement device 32 starts to be engaged in order to increase the rotational speed of the internal combustion engine EG until downshifting is completed. However, the present disclosure is not limited to such a configuration. For example, the torque control in which the torque Tmg of the rotating electrical machine MG is controlled to follow the target torque may be performed during the entire period of the start-shift parallel control in the entire period.

(2) The above embodiment is described with respect to the configuration in which the rotating electrical machine MG outputs the maximum torque Tmg·Max during the period from the time the rotational speed of the internal combustion engine EG starts to increase by engagement of the transmission engagement device 32 until the torque Teg of the internal combustion engine EG starts to be transmitted to the output member 36 by engagement of the transmission engagement device 32 after completion of downshifting. However, the present disclosure is not limited to such a configuration. For example, the torque Tmg of the rotating electrical machine MG during this period may be constant torque smaller than the maximum torque Tmg·Max, or the torque Tmg of the rotating electrical machine MG may be controlled to fluctuate.

(3) The above embodiment is described with respect to the configuration in which the transmission engagement device 32 is engaged after the rotational speed Neg of the internal combustion engine EG becomes higher than the post-downshift synchronous rotational speed Na after completion of downshifting. However, the present disclosure is not limited to such a configuration. For example, the transmission engagement device 32 may be engaged with the rotational speed Neg of the internal combustion engine EG being lower than the post-downshift synchronous rotational speed Na after completion of downshifting.

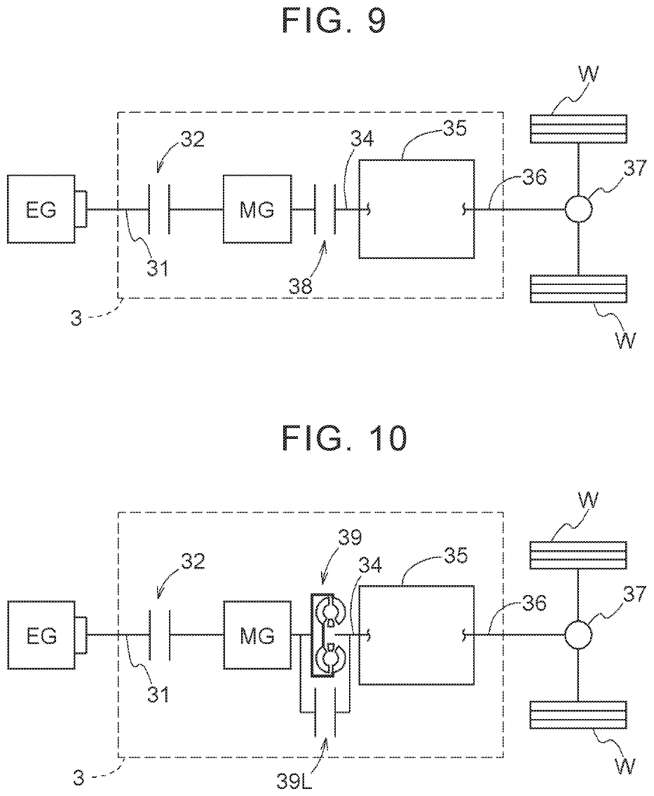

(4) The above embodiment is described with respect to the example in which the vehicle drive device 3 in which the transmission engagement device 32 is the only engagement device provided between the input member 31 and the automatic transmission 35 on the power transmission path is to be controlled. However, the present disclosure is not limited to such a configuration. As shown in, e.g., FIG. 9, the vehicle drive device 3 to be controlled may be configured so that an engagement device 38 is also provided between the rotating electrical machine MG and the automatic transmission 35 on the power transmission path. Alternatively, as shown in, e.g., FIG. 10, a fluid coupling 39 (a torque converter, a fluid coupling, etc.) having a direct-coupling engagement device 39L (a lockup clutch) may also be provided between the rotating electrical machine MG and the automatic transmission 35 on the power transmission path.

(5) The above embodiment is described with respect to the configuration in which a shift speed is established by engaging two of the plurality of shift engagement devices 35C. However, the present disclosure is not limited to such a configuration. For example, a shift speed may be established by engaging one or three or more shift engagement devices 35C.

(6) The above embodiment is described with respect to the example in which the vehicle drive device 3 including as the automatic transmission 35 a stepped automatic transmission (in the example of FIG. 2, an eight-speed stepped automatic transmission) having a plurality of planetary gear mechanisms and a plurality of shift engagement devices 35C is to be controlled. However, the present disclosure is not limited to such a configuration. For example, in the vehicle drive device 3 to be controlled, two- to seven-speed or nine- or more speed stepped automatic transmissions may be used as the automatic transmission 35. Alternatively, for example, other types of automatic transmission such as a continuously variable transmission and a dual clutch transmission (DCT) may be used as the automatic transmission 35.

(7) The configuration disclosed in each of the embodiments described above may be combined with the configuration disclosed in any of the other embodiments unless inconsistency arises. Regarding other configurations as well, the embodiments disclosed herein are merely illustrative in all respects. Accordingly, various modifications can be made as appropriate without departing from the spirit and scope of the present disclosure.

### Summary of the Embodiment

The summary of the control device 1 described above will be presented.

This control device (1) is a control device (1) that controls a vehicle drive device (3) in which an engagement device (32), a rotating electrical machine (MG), and an automatic transmission (35) are arranged in this order from an input member (31) side on a power transmission path connecting an input member (31) drivingly coupled to an internal combustion engine (EG) and an output member (36) drivingly coupled to a wheel (W). When starting of the internal combustion engine (EG) and downshifting are performed in a state in which the internal combustion engine (EG) is stopped, the engagement device (32) is disengaged, and torque (Tmg) of the rotating electrical machine (MG) is transmitted to the wheel (W), the engagement device (32) is engaged to increase a rotational speed (Neg) of the internal combustion engine (EG) to a startable rotational speed (Nig), after the rotational speed (Neg) of the internal combustion engine (EG) is increased to the startable rotational speed (Nig), the internal combustion engine (EG) is ignited and the engagement device (32) is then disengaged. After the ignition of the internal combustion engine (EG), the rotational speed (Neg) of the internal combustion engine (EG) is increased toward a post-downshift synchronous rotational speed (Na) by torque (Teg) of the internal combustion engine (EG). After the disengagement of the engagement device (32), a rotational speed (Nin) of the rotating electrical machine (MG) is increased toward the post-downshift synchronous rotational speed (Na) to perform the downshifting of the automatic transmission. The engagement device (32) is engaged after completion of the downshifting. The startable rotational speed (Nig) is a rotational speed at which the internal combustion engine (EG) can be started by ignition, and the post-downshift synchronous rotational speed (Na) is a rotational speed (Nin) of the rotating electrical machine (MG) after completion of the downshifting in the case where the downshifting in which a speed ratio of the automatic transmission (35) is changed to a higher one is performed.

According to this configuration, the engagement device (32) is disengaged after the engagement device (32) is engaged and the rotational speed (Neg) of the internal combustion engine (EG) is increased to the startable rotational speed (Nig). The rotational speed can therefore be changed for the downshifting with the rotating electrical machine (MG) being disconnected from the internal combustion engine (EG). Since there is no inertia of the internal combustion engine (EG), the rotational speed (Nin) of the rotating electrical machine (MG) can be quickly made close to the post-downshift synchronous rotational speed (Na) and downshifting of the automatic transmission (35) can be quickly completed. The torque (Tmg) of the rotating electrical machine (MG) from which the inertia torque for changing the rotational speeds (Nin) of the internal combustion engine (EG) and the rotating electrical machine (MG) has not been subtracted can be quickly transmitted to the wheel (W) at the speed ratio after the downshift. After the rotational speed of the internal combustion engine (EG) is increased to the startable rotational speed (Nig) and the internal combustion engine (EG) is ignited, the rotational speed of the internal combustion engine (EG) is increased toward the post-downshift synchronous rotational speed (Na) by the torque of the internal combustion engine (EG) itself. The engagement device (32) can therefore be smoothly engaged after completion of the downshifting. After the engagement of the engagement device (32), the torque (Teg) of the internal combustion engine (EG) can also be transmitted to the wheel (W) at the speed ratio after the downshift. Large torque can therefore be transmitted to the wheel (W).

It is preferable that rotational speed control in which the rotational speed of the rotating electrical machine (MG) is controlled to follow a target rotational speed (Nt) be performed during a period from the time the engagement device (32) starts to be engaged in order to increase the rotational speed (Neg) of the internal combustion engine (EG) until the downshifting is completed.

According to this configuration, the rotational speed (Nin) of the rotating electrical machine (MG) can be stabilized in accordance with the target rotational speed (Nt) regardless of torque fluctuations due to engagement of the engagement device (32) and torque fluctuations due to an increase in rotational speed (Nin) of the rotating electrical machine (MG) for downshifting. The traveling state of the vehicle during this period can therefore be stabilized.

It is preferable that the rotating electrical machine (MG) output maximum torque (Tmg·Max) during a period from the time the rotational speed (Neg) of the internal combustion engine (EG) starts to increase by the engagement of the engagement device (32) until the torque (Teg) of the internal combustion engine (EG) starts to be transmitted to the output member (36) by the engagement of the engagement device (32) after completion of the downshifting.

This configuration can reduce the period from the time the rotational speed (Neg) of the internal combustion engine (EG) is increased to the startable rotational speed (Nin) until the rotational speed (Nin) of the rotating electrical machine (MG) is then increased toward the post-downshift synchronous rotational speed (Na) and the downshifting of the automatic transmission (35) is completed. After completion of the downshifting, the maximum torque (Tmg·Max) of the rotating electrical machine (MG) can be transmitted to the wheel (W).

It is preferable that the engagement device (32) be engaged after the rotational speed (Neg) of the internal combustion engine (EG) becomes higher than the post-downshift synchronous rotational speed (Na) after completion of the downshifting,

According to this configuration, negative torque can be restrained from being transmitted toward the wheel (W) side when the engagement device (32) is engaged. Shock in the deceleration direction can therefore be restrained from occurring in the vehicle during acceleration.

It is preferable that an engagement pressure (P2) of a disengage-side engagement device (35R) of the automatic transmission (35) be reduced as preparation for the downshifting during a period that overlaps a period in which the engagement device (32) is engaged to increase the rotational speed (Neg) of the internal combustion engine (EG) to the startable rotational speed (Nig), the disengage-side engagement device (35R) being a shift engagement device (35C) that changes from an engaged state to a disengaged state by the downshifting out of a plurality of shift engagement devices (35C) included in the automatic transmission (35).

According to this configuration, the engagement pressure (P2) of the disengage-side engagement device (35R) can be reduced by using the period during which the rotational speed (Neg) of the internal combustion engine (EG) is increased to the startable rotational speed (Nig). The downshifting can therefore be quickly performed after the internal combustion engine (EG) is started and the engagement device (32) is disengaged. The torque (Tmg) of the rotating electrical machine (MG) can thus be quickly transmitted to the wheel (W) at the speed ratio after the downshift.

It is preferable that the engagement device (32) be switched to a direct-coupling engaged state after an engage-side engagement device (35A) is switched to a direct-coupling engaged state by the downshifting, the engage-side engagement device (35A) being a shift engagement device (35C) that changes from a disengaged state to an engaged state by the downshifting out of the plurality of shift engagement devices (35C) included in the automatic transmission (35).

According to this configuration, the engagement device (32) is engaged after the downshifting is completed. The torque (Teg) of the internal combustion engine (EG) can therefore be appropriately transmitted to the wheel (W) at the speed ratio after the downshift after the internal combustion engine (EG) is started.

### INDUSTRIAL APPLICABILITY

The technique according to the present disclosure can be suitably used for control devices that control a vehicle drive device in which an engagement device, a rotating electrical machine, and an automatic transmission are arranged in this order from the input member side on a power transmission path connecting an input member drivingly coupled to an internal combustion engine and an output member drivingly coupled to wheels.

1. A control device that controls a vehicle drive device in which an engagement device, a rotating electrical machine, and an automatic transmission are arranged in this order from an input side on a power transmission path connecting an input drivingly coupled to an internal combustion engine and an output drivingly coupled to a wheel, the control device comprising:
an electronic control unit is configured to, when starting of the internal combustion engine and downshifting are performed in parallel in a state in which the internal combustion engine is stopped and the engagement device is disengaged so that torque of the rotating electrical machine is transmitted to the wheel:
engage the engagement device to increase a rotational speed of the internal combustion engine to a startable rotational speed,
after the rotational speed of the internal combustion engine is increased to the startable rotational speed, ignite the internal combustion engine and then disengage the engagement device,
after the ignition of the internal combustion engine, increase the rotational speed of the internal combustion engine toward a post-downshift synchronous rotational speed by torque of the internal combustion engine,
after the disengagement of the engagement device, increase a rotational speed of the rotating electrical machine toward the post-downshift synchronous rotational speed to perform the downshifting of the automatic transmission, and
engage the engagement device after completion of the downshifting.
the startable rotational speed being a rotational speed at which the internal combustion engine is able to be started by ignition, and the post-downshift synchronous rotational speed being a rotational speed of the rotating electrical machine after completion of the downshifting in the case where the downshifting in which a speed ratio of the automatic transmission is changed to a higher one is performed.

2. The control device according to claim 1, wherein
the electronic control unit performs rotational speed control in which the rotational speed of the rotating electrical machine is controlled to follow a target rotational speed during a period from the time the engagement device starts to be engaged in order to increase the rotational speed of the internal combustion engine until the downshifting is completed.

3. The control device according to claim 1, wherein
the rotating electrical machine outputs maximum torque during a period from the time the rotational speed of the internal combustion engine starts to increase by the engagement of the engagement device until the torque of the internal combustion engine starts to be transmitted to the output by the engagement of the engagement device after completion of the downshifting.

4. The control device according to claim 1, wherein
the electronic control unit engages the engagement device after the rotational speed of the internal combustion engine becomes higher than the post-downshift synchronous rotational speed after completion of the downshifting.

5. The control device according to claim 1, wherein
the electronic control unit reduces an engagement pressure of a disengage-side engagement device of the automatic transmission as preparation for the downshifting during a period that overlaps a period in which the engagement device is engaged to increase the rotational speed of the internal combustion engine to the startable rotational speed,
the disengage-side engagement device being a shift engagement device that changes from an engaged state to a disengaged state by the downshifting out of a plurality of shift engagement devices included in the automatic transmission.

6. The control device according to claim 1, wherein
the electronic control unit switches the engagement device to a direct-coupling engaged state after an engage-side engagement device is switched to a direct-coupling engaged state by the downshifting,
the engage-side engagement device being a shift engagement device that changes from a disengaged state to an engaged state by the downshifting out of a plurality of shift engagement devices included in the automatic transmission.

7. The control device according to claim 2, wherein
the rotating electrical machine outputs maximum torque during a period from the time the rotational speed of the internal combustion engine starts to increase by the engagement of the engagement device until the torque of the internal combustion engine starts to be transmitted to the output by the engagement of the engagement device after completion of the downshifting.

8. The control device according to claim 2, wherein
the electronic control unit engages the engagement device after the rotational speed of the internal combustion engine becomes higher than the post-downshift synchronous rotational speed after completion of the downshifting.

9. The control device according to claim 2, wherein
the electronic control unit reduces an engagement pressure of a disengage-side engagement device of the automatic transmission as preparation for the downshifting during a period that overlaps a period in which the engagement device is engaged to increase the rotational speed of the internal combustion engine to the startable rotational speed,
the disengage-side engagement device being a shift engagement device that changes from an engaged state to a disengaged state by the downshifting out of a plurality of shift engagement devices included in the automatic transmission.

10. The control device according to claim 2, wherein
the electronic control unit switches the engagement device to a direct-coupling engaged state after an engage-side engagement device is switched to a direct-coupling engaged state by the downshifting,
the engage-side engagement device being a shift engagement device that changes from a disengaged state to an engaged state by the downshifting out of a plurality of shift engagement devices included in the automatic transmission.

11. The control device according to claim 3, wherein
the electronic control unit engages the engagement device after the rotational speed of the internal combustion engine becomes higher than the post-downshift synchronous rotational speed after completion of the downshifting.

12. The control device according to claim 3, wherein
the electronic control unit reduces an engagement pressure of a disengage-side engagement device of the automatic transmission as preparation for the downshifting during a period that overlaps a period in which the engagement device is engaged to increase the rotational speed of the internal combustion engine to the startable rotational speed,
the disengage-side engagement device being a shift engagement device that changes from an engaged state to a disengaged state by the downshifting out of a plurality of shift engagement devices included in the automatic transmission.

13. The control device according to claim 3, wherein
the electronic control unit switches the engagement device to a direct-coupling engaged state after an engage-side engagement device is switched to a direct-coupling engaged state by the downshifting,
the engage-side engagement device being a shift engagement device that changes from a disengaged state to an engaged state by the downshifting out of a plurality of shift engagement devices included in the automatic transmission.

14. The control device according to claim 4, wherein
the electronic control unit reduces an engagement pressure of a disengage-side engagement device of the automatic transmission as preparation for the downshifting during a period that overlaps a period in which the engagement device is engaged to increase the rotational speed of the internal combustion engine to the startable rotational speed,
the disengage-side engagement device being a shift engagement device that changes from an engaged state to a disengaged state by the downshifting out of a plurality of shift engagement devices included in the automatic transmission.

15. The control device according to claim 4, wherein
the electronic control unit switches the engagement device to a direct-coupling engaged state after an engage-side engagement device is switched to a direct-coupling engaged state by the downshifting,
the engage-side engagement device being a shift engagement device that changes from a disengaged state to an engaged state by the downshifting out of a plurality of shift engagement devices included in the automatic transmission.

16. The control device according to claim 5, wherein
the electronic control unit switches the engagement device to a direct-coupling engaged state after an engage-side engagement device is switched to a direct-coupling engaged state by the downshifting,
the engage-side engagement device being a shift engagement device that changes from a disengaged state to an engaged state by the downshifting out of a plurality of shift engagement devices included in the automatic transmission.

17. The control device according to claim 7, wherein
the electronic control unit engages the engagement device after the rotational speed of the internal combustion engine becomes higher than the post-downshift synchronous rotational speed after completion of the downshifting.

18. The control device according to claim 7, wherein
the electronic control unit reduces an engagement pressure of a disengage-side engagement device of the automatic transmission as preparation for the downshifting during a period that overlaps a period in which the engagement device is engaged to increase the rotational speed of the internal combustion engine to the startable rotational speed,
the disengage-side engagement device being a shift engagement device that changes from an engaged state to a disengaged state by the downshifting out of a plurality of shift engagement devices included in the automatic transmission.

19. The control device according to claim 7, wherein
the electronic control unit switches the engagement device to a direct-coupling engaged state after an engage-side engagement device is switched to a direct-coupling engaged state by the downshifting,
the engage-side engagement device being a shift engagement device that changes from a disengaged state to an engaged state by the downshifting out of a plurality of shift engagement devices included in the automatic transmission.

20. The control device according to claim 8, wherein
the electronic control unit reduces an engagement pressure of a disengage-side engagement device of the automatic transmission as preparation for the downshifting during a period that overlaps a period in which the engagement device is engaged to increase the rotational speed of the internal combustion engine to the startable rotational speed,
the disengage-side engagement device being a shift engagement device that changes from an engaged state to a disengaged state by the downshifting out of a plurality of shift engagement devices included in the automatic transmission.
